(19) United States
(12) Patent Application Publication
(10) Pub. No.: US 2026/0073500 A1
(43) Pub. Date: Mar. 12, 2026

(54) DEFECT DETECTION USING MULTIPLE ALGORITHMS

(71) Applicant: Applied Materials Israel Ltd., Rehovot (IL)

(72) Inventors: Nir BARAM, Ness Ziona (IL); Chen RAICH, Kibbutz Nir Am (IL); Yoav ROSENBERG, Meitar (IL); Eli Alexander KAMINSKY, Gan Yavne (IL); Aviad YAHALOM, Lavon (IL)

(21) Appl. No.: 18/884,042

(22) Filed: Sep. 12, 2024

(51) Int. Cl. G06T 7/00; G01N 21/88; G01N 21/95

(52) U.S. Cl. CPC G06T 7/0004; G01N 21/8851; G01N 21/9501; G01N 2021/8854; G01N 2021/8887; G06T 2207/20081; G06T 2207/30148

(57) ABSTRACT

There are provided systems and methods comprising obtaining a first set of candidate defects of a semiconductor specimen, acquired by an inspection tool associated with a first set of acquisition parameters, using one or more first algorithms to generate, based on the first set of candidate defects, a first reduced set of candidate defects, obtaining a second set of candidate defects of the specimen, acquired by the inspection tool associated with a second set of acquisition parameters, using the one or more first algorithms to generate, based on the second set of candidate defects, a second reduced set of candidate defects, comprising less candidate defects than the second set of candidate defects, and feeding the first reduced set of candidate defects and the second reduced set of candidate defects to a second algorithm, to generate a unified set of candidate defects.

### TECHNICAL FIELD

The presently disclosed subject matter relates, in general, to the field of examination of a specimen, and more specifically, to automating the examination of a specimen.

### BACKGROUND

Current demands for high density and performance associated with ultra large-scale integration of fabricated devices require submicron features, increased transistor and circuit speeds, and improved reliability. Such demands require formation of device features with high precision and uniformity, which, in turn, necessitates careful monitoring of the fabrication process, including automated examination of the devices while they are still in the form of semiconductor wafers.

Examination processes are used at various steps during semiconductor fabrication to detect and classify defects on specimens (e.g., Automatic Defect Classification (ADC), Automatic Defect Review (ADR), etc.).

### GENERAL DESCRIPTION

In accordance with certain aspects of the presently disclosed subject matter, there is provided a system comprising one or more processing circuitries configured to obtain a first set of candidate defects of a semiconductor specimen, wherein the first set of candidate defects has been obtained based on at least one image of the semiconductor specimen acquired by an inspection tool associated with a first set of acquisition parameters, use one or more first algorithms to generate, based on the first set of candidate defects, a first reduced set of candidate defects, comprising less candidate defects than the first set of candidate defects, obtain a second set of candidate defects of the semiconductor specimen, wherein the second set of candidate defects has been obtained based on at least one image of the semiconductor specimen acquired by the inspection tool associated with a second set of acquisition parameters, different from the first set of acquisition parameters, use the one or more first algorithms to generate, based on the second set of candidate defects, a second reduced set of candidate defects, comprising less candidate defects than the second set of candidate defects, and feed at least part of the first reduced set of candidate defects and at least part of the second reduced set of candidate defects to a second algorithm, to generate a unified set of candidate defects.

In addition to the above features, the system according to this aspect of the presently disclosed subject matter can comprise one or more of features (i) to (xv) listed below, in any desired combination or permutation which is technically possible:
(i). the system is configured to provide the unified set of candidate defects to a review tool, wherein the review tool is an electron beam examination tool;
(ii). the one or more first algorithms are unsupervised algorithms, and the second algorithm is a supervised algorithm;
(iii). at least one algorithm of the one or more first algorithms has been trained with one or more training images comprising one or more synthetic defects planted in the one or more training images;
(iv). at least one algorithm of the one or more first algorithms has been trained with one or more training images comprising one or more synthetic defects planted in the one or more training images, wherein each of the one or more training images is associated with a label indicative of a presence of a synthetic defect, wherein said label does not require user annotation;
(v). the one or more first algorithms comprise an initial first algorithm configured to convert the first set of candidate defects into a first intermediate set of candidate defects, comprising less candidate defects than the first set of candidate defects;
(vi). the one or more first algorithms comprise an initial first algorithm configured to convert the second set of candidate defects into a second intermediate set of candidate defects, comprising less candidate defects than the second set of candidate defects.
(vii). an algorithm of the one or more first algorithms comprises a classifier configured to assign to each candidate defect of the first set of candidate defects, a label, and a filter configured to classify an output of the classifier, based on attributes informative of candidate defects of the first set;
(viii). an algorithm of the one or more first algorithms comprises a classifier configured to assign to each candidate defect of the second set of candidate defects, a label, and a filter configured to classify an output of the classifier, based on attributes informative of candidate defects of the second set;
(ix). the one or more first algorithms comprise an initial first algorithm configured to convert the first set of candidate defects into a first intermediate set of candidate defects, comprising less candidate defects than the first set of candidate defects, and an additional first algorithm configured to select, in the first intermediate set of candidate defects, a first subset of candidate defects, to generate the first reduced set of candidate defects, comprising less candidate defects than the first intermediate set of candidate defects;
(x). the one or more first algorithms comprise an initial first algorithm configured to convert the second set of candidate defects into a second intermediate set of candidate defects, comprising less candidate defects than the second set of candidate defects, and an additional first algorithm configured to select, in the second intermediate set of candidate defects, a second subset of candidate defects, to generate the second reduced set of candidate defects, comprising less candidate defects than the second intermediate set of candidate defects;
(xi). an algorithm of the one or more first algorithms comprises two classifiers, wherein an aggregation of respective outputs of the two classifiers enables generating the first reduced set of candidate defects or the second reduced set of candidate defects;
(xii). the second algorithm comprises a classifier, configured to classify the first reduced set of candidate defects and the second reduced set of candidate defects into a plurality of defect classes such that each candidate defect is associated with a respective defect class; and a decision model configured to rank the first reduced set of candidate defects and the second reduced set of candidate defects, using a sorting rule;
(xiii). the system further comprises, or is coupled to, a database storing, for each given candidate defect of a plurality of candidate defects, wherein some of the plurality of candidate defects have been reviewed by a first review tool, and some of the plurality of candidate defects have been reviewed by a second review tool, different from the first review tool: a label indicative of a presence of a defect, obtained based on review by the first review tool or the second review tool, and data informative of the given candidate defect;
(xiv). at least some of the plurality of candidate defects have been obtained based on an output of said second algorithm; and
(xv). the system is configured to use at least part of the data of the database to retrain the second algorithm, or another algorithm implementing a same model as the second algorithm.

In accordance with other aspects of the presently disclosed subject matter, there is provided a computer-implemented method comprising obtaining a first set of candidate defects of a semiconductor specimen, wherein the first set of candidate defects has been obtained based on at least one image of the semiconductor specimen acquired by an inspection tool associated with a first set of acquisition parameters, using one or more first algorithms to generate, based on the first set of candidate defects, a first reduced set of candidate defects, comprising less candidate defects than the first set of candidate defects, obtaining a second set of candidate defects of the semiconductor specimen, wherein the second set of candidate defects has been obtained based on at least one image of the semiconductor specimen acquired by the inspection tool associated with a second set of acquisition parameters, different from the first set of acquisition parameters, using the one or more first algorithms to generate, based on the second set of candidate defects, a second reduced set of candidate defects, comprising less candidate defects than the second set of candidate defects, and feed at least part of the first reduced set of candidate defects and at least part of the second reduced set of candidate defects to a second algorithm, to generate a unified set of candidate defects.

In addition to the above features, the method according to this aspect of the presently disclosed subject matter can comprise one or more of features (i) to (xv) listed above, in any desired combination or permutation which is technically possible.

In accordance with other aspects of the presently disclosed subject matter, there is provided a non-transitory computer readable medium comprising instructions that, when executed by at least one or more processing circuitries, cause the at least one or more processing circuitries to perform: obtaining a first set of candidate defects of a semiconductor specimen, wherein the first set of candidate defects has been obtained based on at least one image of the semiconductor specimen acquired by an inspection tool associated with a first set of acquisition parameters, using one or more first algorithms to generate, based on the first set of candidate defects, a first reduced set of candidate defects, comprising less candidate defects than the first set of candidate defects, obtaining a second set of candidate defects of the semiconductor specimen, wherein the second set of candidate defects has been obtained based on at least one image of the semiconductor specimen acquired by the inspection tool associated with a second set of acquisition parameters, different from the first set of acquisition parameters, using the one or more first algorithms to generate, based on the second set of candidate defects, a second reduced set of candidate defects, comprising less candidate defects than the second set of candidate defects, and feed at least part of the first reduced set of candidate defects and at least part of the second reduced set of candidate defects to a second algorithm, to generate a unified set of candidate defects.

In addition to the above features, the non-transitory computer readable medium can comprise instructions that, when executed by one or more processing circuitries, cause the one or more processing circuitries to perform one or more of features (i) to (xv) listed above, in any desired combination or permutation which is technically possible.

In accordance with other aspects of the presently disclosed subject matter, there is provided a system comprising one or more processing circuitries configured to obtain a set of candidate defects of a semiconductor specimen, wherein the set of candidate defects has been obtained based on at least one image of the semiconductor specimen acquired by an inspection tool, use one or more first algorithms to generate, based on the set of candidate defects, a reduced set of candidate defects, comprising less defects than the set of candidate defects, and feed the reduced set of candidate defects to a second algorithm to generate a final set of candidate defects, comprising less candidate defects than the set of candidate defects.

In addition to the above features, the system according to this aspect of the presently disclosed subject matter can comprise one or more of features (i) to (xv) listed above, and/or one or more features (xvi) to (xxiii) listed below, in any desired combination or permutation which is technically possible:
(xvi). the one or more first algorithms are unsupervised algorithms and the second algorithm is a supervised algorithm;
(xvii). the system comprises, or is coupled to, a database storing, for each given candidate defect of a plurality of candidate defects, wherein some of the plurality of candidate defects have been reviewed by a first review tool, and some of the plurality of candidate defects have been reviewed by a second review tool, different from the first review tool: a label indicative of a presence of a defect, obtained based on review by the first review tool or the second review tool, data informative of the given candidate defect;
(xviii). the plurality of candidate defects has been obtained based on an output of said second algorithm, or another algorithm implementing a same model as the second algorithm;
(xix). the one or more processing circuitries, or one or more different processing circuitries, are configured to use at least part of the data of the database to retrain the second algorithm, or another algorithm implementing a same model as the second algorithm;
(xx). the one or more processing circuitries, or one or more different processing circuitries, are configured to use at least part of the data of the database to retrain the second algorithm, or another algorithm implementing a same model as the second algorithm, wherein said retraining is triggered automatically when a condition is met;
(xxi). the one or more processing circuitries, or the one or more different processing circuitries, are configured to trigger transmission of the second algorithm after its retraining, or of said another algorithm after its retraining, to the first review tool and the second review tool, or to a first system operative to communicate with the first review tool and to a second system operative to communicate with the second review tool;
(xxii). at least part of the data stored in the database is automatically received from a fleet of review tools comprising the first review tool and the second review tool; and
(xxiii). the one or more processing circuitries, or the one or more different processing circuitries, are configured to extract, from the database, data associated with candidate defects of a given class or a given location, and retrain the second algorithm, or said another algorithm implementing a same model as the second algorithm, with said data.

In accordance with other aspects of the presently disclosed subject matter, there is provided a computer-implemented method comprising obtaining a set of candidate defects of a semiconductor specimen, wherein the set of candidate defects has been obtained based on at least one image of the semiconductor specimen acquired by an inspection tool, use one or more first algorithms to generate, based on the set of candidate defects, a reduced set of candidate defects, comprising less defects than the set of candidate defects, and feed the reduced set of candidate defects to a second algorithm to generate a final set of candidate defects, comprising less candidate defects than the set of candidate defects.

In addition to the above features, the method according to this aspect of the presently disclosed subject matter can comprise one or more of features (i) to (xxiii) listed above, in any desired combination or permutation which is technically possible.

In accordance with other aspects of the presently disclosed subject matter, there is provided a non-transitory computer readable medium comprising instructions that, when executed by at least one or more processing circuitries, cause the at least one or more processing circuitries to perform: obtaining a set of candidate defects of a semiconductor specimen, wherein the set of candidate defects has been obtained based on at least one image of the semiconductor specimen acquired by an inspection tool, use one or more first algorithms to generate, based on the set of candidate defects, a reduced set of candidate defects, comprising less defects than the set of candidate defects, and feed the reduced set of candidate defects to a second algorithm to generate a final set of candidate defects, comprising less candidate defects than the set of candidate defects.

In addition to the above features, the non-transitory computer readable medium comprises instructions that, when executed by one or more processing circuitries, cause the one or more processing circuitries to perform one or more of features (i) to (xxiii) listed above, in any desired combination or permutation which is technically possible.

In accordance with other aspects of the presently disclosed subject matter, there is provided a system comprising a database storing, for each given candidate defect of a plurality of candidate defects, wherein some of the plurality of candidate defects have been reviewed by a first review tool, and some of the plurality of candidate defects have been reviewed by a second review tool, different from the first review tool: a label indicative of a presence of a defect, obtained based on review of the given candidate defect by the first review tool or the second review tool, and data informative of the given candidate defect.

In addition to the above features, the system according to this aspect of the presently disclosed subject matter can comprise one or more of features (i) to (xxiii) listed above, and/or one or more features (xxiv) to (xxxv) listed below, in any desired combination or permutation which is technically possible:
(xxiv). the system further comprises one or more processing circuitries configured to use at least part of the data from the database to train or retrain an algorithm;
(xxv). at least some of the candidate defects have been provided by the algorithm, or by another algorithm implementing a same model as the algorithm;
(xxvi). the system is configured to distribute the algorithm, after said training or said retraining, to the first review tool and the second review tool, or to a first system operative to communicate with the first review tool and to a second system operative to communicate with the second review tool;
(xxvii). the system is configured to automatically distribute the algorithm, after said training or said retraining, to the first review tool and the second review tool, or to a first system operative to communicate with the first review tool and to a second system operative to communicate with the second review tool;
(xxviii). said training or said retraining is triggered automatically when a condition is met;
(xxix). said condition depends on an amount of data informative of defects or of candidate defects, collected in the database;
(xxx). the system is configured to raise an alert when said algorithm has been trained or retrained;
(xxxi). at least part of the data stored in the database is automatically received from a fleet of review tools comprising the first review tool and the second review tool;
(xxxii). the system further comprises one or more processing circuitries configured to extract, from the database, data associated with candidate defects associated with a given class or a given location, and train or retrain an algorithm with said data;
(xxxiii). the algorithm is operative to generate, based on a first set of candidate defects and a second reduced set of candidate defects, a unified set of candidate defects, comprising less candidate defects than a total number of candidate defects present in the first and second sets;
(xxxiv). the algorithm is a supervised algorithm; and
(xxxv). the algorithm comprises a classifier, configured to classify a set of candidate defects into a plurality of defect classes such that each candidate defect is associated with a respective defect class; and a decision model configured to rank the set of candidate defects using a sorting rule.

In accordance with other aspects of the presently disclosed subject matter, there is provided a computer-implemented method comprising storing, in a database, for each given candidate defect of a plurality of candidate defects, wherein some of the plurality of candidate defects have been reviewed by a first review tool, and some of the plurality of candidate defects have been reviewed by a second review tool, different from the first review tool: a label indicative of a presence of a defect, obtained based on review of the given candidate defect by the first review tool or the second review tool, and data informative of the given candidate defect.

In addition to the above features, the method according to this aspect of the presently disclosed subject matter can comprise one or more of features (i) to (xxxv) listed above, in any desired combination or permutation which is technically possible.

In accordance with other aspects of the presently disclosed subject matter, there is provided a non-transitory computer readable medium comprising instructions that, when executed by at least one or more processing circuitries, cause the at least one or more processing circuitries to perform: storing, in a database, for each given candidate defect of a plurality of candidate defects, wherein some of the plurality of candidate defects have been reviewed by a first review tool, and some of the plurality of candidate defects have been reviewed by a second review tool, different from the first review tool: a label indicative of a presence of a defect, obtained based on review by the first review tool or the second review tool, and data informative of the given candidate defect.

In addition to the above features, the non-transitory computer readable medium comprises instructions that, when executed by one or more processing circuitries, cause the one or more processing circuitries to perform one or more of features (i) to (xxxv) listed above, in any desired combination or permutation which is technically possible.

The proposed solution provides various technical advantages. At least some of them are listed hereinafter.

According to some examples, the proposed solution enables efficient and accurate detection of defects in an image of a semiconductor specimen.

According to some examples, the proposed solution reduces user intervention in the detection of defects.

According to some examples, the proposed solution improves the defect of interest (DOI) capture rate, while reducing the false alarm rate (FAR).

According to some examples, the proposed solution improves the ability to differentiate between actual defects and noise.

According to some examples, the proposed solution exploits the strength of each of a plurality of algorithms to improve defect detection.

According to some examples, the proposed solution provides an automated system.

According to some examples, the proposed solution provides a user-friendly solution.

According to some examples, the proposed solution reduces the time required to detect the defects.

According to some examples, the proposed solution enables automatic collection of data from a whole fleet of examination tools, and automatic retraining of one or more algorithms based on this data.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 illustrates a generalized block diagram of an examination system in accordance with certain examples of the presently disclosed subject matter.

FIG. 2 illustrates a generalized flow-chart of a method of generating a reduced map of candidate defects, for review by a review tool, in accordance with certain examples of the presently disclosed subject matter.

FIG. 3A illustrates an architecture involving multiple algorithms, usable to perform the method of FIG. 2, in accordance with certain examples of the presently disclosed subject matter.

FIG. 3B illustrates a generalized flow-chart of a method of generating a reduced map of candidate defects, for review by a review tool, in accordance with certain examples of the presently disclosed subject matter.

FIG. 4 illustrates an initial first algorithm present in the architecture of FIG. 3A, in accordance with certain examples of the presently disclosed subject matter.

FIG. 5A illustrates an additional first algorithm present in the architecture of FIG. 3A, in accordance with certain examples of the presently disclosed subject matter.

FIG. 5B illustrates a generalized flow-chart of a method of generating a training set, by planting synthetic defect into images, in accordance with certain examples of the presently disclosed subject matter.

FIG. 6 illustrates a second algorithm present in the architecture of FIG. 3A, in accordance with certain examples of the presently disclosed subject matter.

FIG. 7 illustrates an inspection dataset fed to a second algorithm present in the architecture of FIG. 3A, in accordance with certain examples of the presently disclosed subject matter.

FIG. 8 illustrates an output of a classifier of the second algorithm present in the architecture of FIG. 3A, in accordance with certain examples of the presently disclosed subject matter.

FIG. 9 illustrates an output of a decision model of the second algorithm present in the architecture of FIG. 3A, in accordance with certain examples of the presently disclosed subject matter.

FIG. 10 illustrates a generalized flow-chart of another method of generating a reduced map of candidate defects, for review by a review tool, in accordance with certain examples of the presently disclosed subject matter.

FIG. 11 illustrates an architecture involving multiple algorithms, usable to perform the method of FIG. 10, in accordance with certain examples of the presently disclosed subject matter.

FIG. 12A illustrates an architecture enabling collecting data from a fleet of examination tools, in accordance with certain examples of the presently disclosed subject matter.

FIG. 12B illustrates another architecture enabling collecting data from a fleet of examination tools, in accordance with certain examples of the presently disclosed subject matter.

FIG. 12C illustrates another architecture enabling collecting data from a fleet of examination tools, in accordance with certain examples of the presently disclosed subject matter.

FIG. 13 illustrates a generalized flow-chart of a method of retraining an algorithm based on data collected using the architecture of FIG. 12, in accordance with certain examples of the presently disclosed subject matter.

FIG. 14 illustrates a generalized flow-chart of another method of retraining an algorithm based on data collected using the architecture of FIG. 12, in accordance with certain examples of the presently disclosed subject matter.

### DETAILED DESCRIPTION OF EMBODIMENTS

Run-time examination can employ a two-phase procedure, e.g., inspection of a specimen by an inspection tool (e.g., an optical examination tool) followed by review of sampled locations of potential defects by a review tool (e.g., by a scanning electron microscope). In the first phase, a defect map is produced to show suspected locations on the specimen having high probability of a defect. During the second phase, at least some of the suspected locations are more thoroughly analyzed with relatively high resolution.

New methods and systems are herein proposed for generating a reduced defect map to be reviewed by the review tool. An initial defect map is provided by an inspection tool. In some examples, a plurality of initial defect maps is provided, obtained based on images acquired using different acquisition parameters (e.g., landing energy, tilt angle, etc.) of the inspection tool. The one or more initial defect maps are fed to a set of one or more first algorithms, which enable generating one or more reduced defect maps (with a smaller number of candidate defects than the one or more initial defect maps). The one or more reduced defect maps are fed to a second algorithm, which generates a unified defect map (with the most relevant defects of interest), to be reviewed by the review tool.

In some examples, a database stores data informative of candidate defects as identified by the second algorithm and reviewed by the review tool. The data can be collected automatically from a fleet of review tools. Once sufficient data has been collected, the data can be used to automatically retrain the second algorithm, which is then distributed across the fleet of review tools.

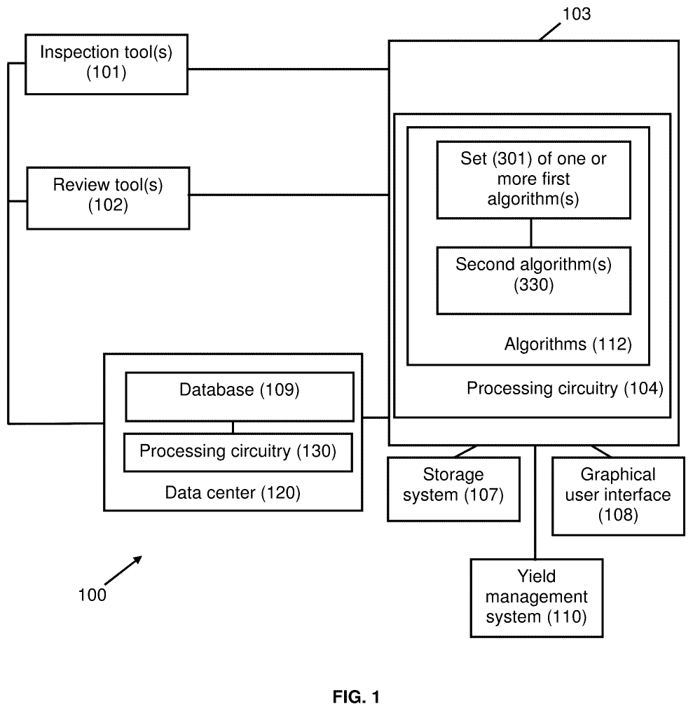

Attention is drawn to FIG. 1 illustrating a functional block diagram of an examination system 100 in accordance with certain examples of the presently disclosed subject matter. The examination system 100 illustrated in FIG. 1 can be used for examination of a specimen (e.g., of a wafer and/or parts thereof) as part of the specimen fabrication process. The illustrated examination system 100 comprises computer-based system 103 capable of automatically determining defect-related information using images obtained during specimen fabrication. System 103 can be operatively connected to one or more examination tools, including one or more inspection tool(s) 101 and/or one or more review tool(s) 102. The examination tools are configured to capture images and/or to review the captured image(s) and/or to enable or provide measurements related to the captured image(s).

As explained hereinafter, the inspection tool 101 provides an image of a specimen, from which at least one (or more) first map of defects is/are generated. The one (or more) first map of defects is/are processed to generate a reduced map of defects, which are then reviewed by the review tool 102. Both the inspection tool 101 and the review tool 102 are examination tools operative to provide data informative of defects. The review tool 102 is generally used to review candidate defects identified based on a preliminary inspection of the specimen performed by the inspection tool 101. In some examples, the resolution of the one or more inspection tools 101 is smaller than the resolution of the review tools 102. By way of non-limiting example, a specimen can be examined by one or more low-resolution inspection tools 101 (e.g., an optical inspection system, low-resolution SEM, etc.), to generate at least one first map of defects. The first map of defects is then processed to generate a reduced map of defects, which are reviewed by a high-resolution review tool 102, such as SEM, an Atomic Force Microscopy (AFM), or another optical examination tool.

In some examples, the one or more inspection tools 101 correspond to optical examination tools (such as, but not limited to, the Enlight™ tool of the Applicant) and the review tools 102 correspond to scanning electron microscopes (SEM). This is not limitative.

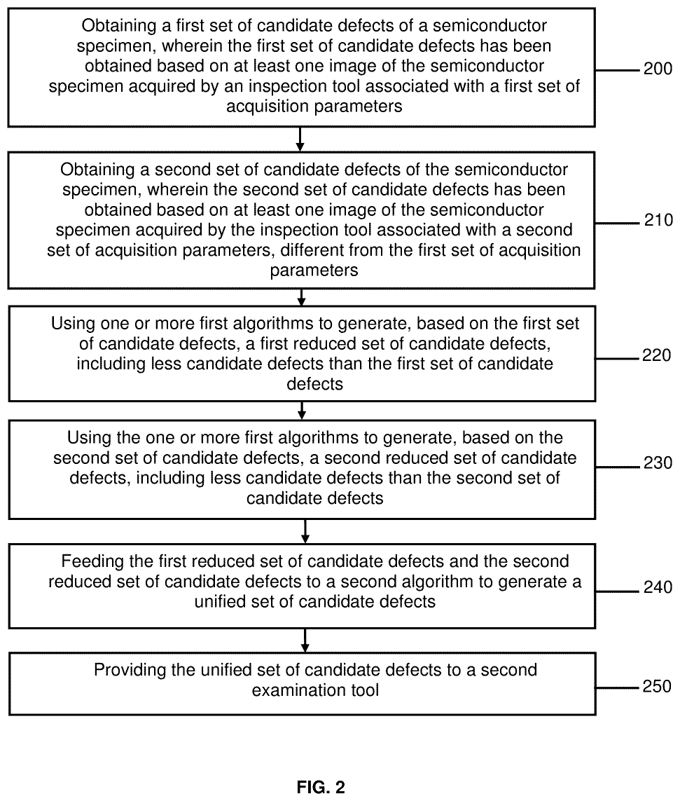

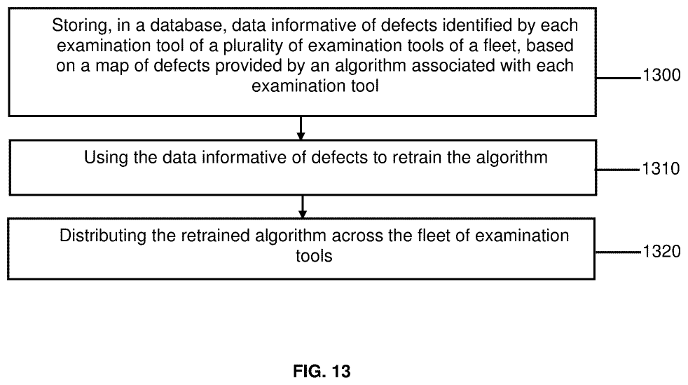

System 103 includes a processing circuitry 104, which includes one or more processors and one or more memories. The processing circuitry 104 is configured to provide all processing necessary for operating the system 103 as further detailed hereinafter (see methods described in FIGS. 2, 3B, 5B, 10, 13 and 14 which can be performed at least partially by system 103 and/or system 100).

The processing circuitry 104 is configured to execute functional modules in accordance with computer-readable instructions implemented on a non-transitory computer-readable memory of the processing circuitry 104 (or operatively coupled to the processing circuitry 104). The functional modules include a plurality of algorithms 112, operative to determine data informative of defects.

The algorithms 112 include a set 301 of one or more first algorithms and one or more second algorithms 330. The nature of these algorithms, and their usage, is further described hereinafter. Note that the processing circuitry 104 can implement a different number of algorithms.

The algorithm(s) 112 can include a machine learning algorithm. Examples of machine learning algorithms include e.g., a decision tree, Support Vector Machine (SVM), Artificial Neural Network (ANN), a regression model, Bayesian network, etc., or ensembles/combinations thereof. In some embodiments, the machine learning algorithm can be implemented as a deep neural network (DNN). DNN can comprise multiple layers organized in accordance with respective DNN architecture. By way of non-limiting example, the layers of DNN can be organized in accordance with Convolutional Neural Network (CNN) architecture, Recurrent Neural Network architecture, Recursive Neural Networks architecture, Generative Adversarial Network (GAN) architecture, or otherwise. Optionally, at least some of the layers can be organized into a plurality of DNN sub-networks. Each layer of DNN can include multiple basic computational elements (CE) typically referred to in the art as dimensions, neurons, or nodes.

The weighting and/or threshold values associated with the CEs of a deep neural network and the connections thereof can be initially selected prior to training, and can be further iteratively adjusted or modified during training to achieve an optimal set of weighting and/or threshold values in a trained DNN. After each iteration, a difference can be determined between the actual output produced by the DNN module and the target output associated with the respective training set of data. The difference can be referred to as an error value. Training can be determined to be complete when a loss/cost function indicative of the error value is less than a predetermined value, or when a limited change in performance between iterations is achieved. A set of input data used to adjust the weights/thresholds of a deep neural network is referred to as a training set.

System 103 can be further operatively connected to a data center 120. The data center 120 includes a database 109. As explained further hereinafter, the database 109 can include data informative of candidate defects identified by one or more of the algorithm(s) 112, and data provided by the review tool(s) 102 upon examination of these candidate defects. The data stored in the database 109 can be collected from a fleet of examination tools (review tools). In some examples, the data center 120 can include a processing circuitry 130, which can use data stored in the database 109. In some examples, the second algorithm 330 can be retrained (by the processing circuitry 130, or by the processing circuitry 104) using a training set including data of the database 109. This will be discussed further hereinafter.

System 103 is configured to receive input data. Input data can include data (and/or derivatives thereof and/or metadata associated therewith) produced by the examination tools (or data generated based on the output of the examination tools), and/or data stored in the database 109 and/or another relevant data depository. It is noted that input data can include at least one of: images (e.g., captured images, images derived from the captured images, simulated images, synthetic images, etc.), associated numeric data (e.g., metadata, hand-crafted attributes, etc.), map of candidate defects, etc. It is further noted that image data can include data related to a layer of interest and/or to one or more other layers of the specimen. It is noted that image data can be received and processed together with metadata (e.g., pixel size, text description of defect type, parameters of image capturing process, etc.) associated therewith.

System 103 can send instructions to any of the examination tool(s), store the results (such as data informative of the location of the defects) in a storage system 107, render the results via a computer-based graphical user interface GUI 108 and/or send the results to the data center 120 (and in particular to the database 109), and/or to an external system and/or to a yield management system (YMS) 110. A yield management system (YMS) is a data management, analysis, and tool system that collects data from the fab, especially during manufacturing ramp ups, in order to improve yield.

Those versed in the art will readily appreciate that the teachings of the presently disclosed subject matter are not bound by the system illustrated in FIG. 1: equivalent and/or modified functionality can be consolidated or divided in another manner, and can be implemented in any appropriate combination of software with firmware and/or hardware.

Without limiting the scope of the disclosure in any way, it should also be noted that the examination tools can be implemented as inspection machines of various types, such as optical imaging machines, electron beam inspection machines, and so on. In some cases, the same examination tool can provide low-resolution image data and high-resolution image data. In some cases, at least one examination tool can have metrology capabilities.

It is noted that the examination system illustrated in FIG. 1 can be implemented in a distributed computing environment, in which the aforementioned functional modules shown in FIG. 1 can be distributed over several local and/or remote devices, and can be linked through a communication network. It is further noted that in some embodiments at least some of the examination tools 101 and/or 102, storage system 107, data center 120, GUI 108, YMS 110 can be external to the examination system 100 and operate in data communication with system 103. System 103 can be implemented as stand-alone computer(s) to be used in conjunction with the examination tools. Alternatively, the respective functions of the system can, at least partly, be integrated with one or more examination tools.

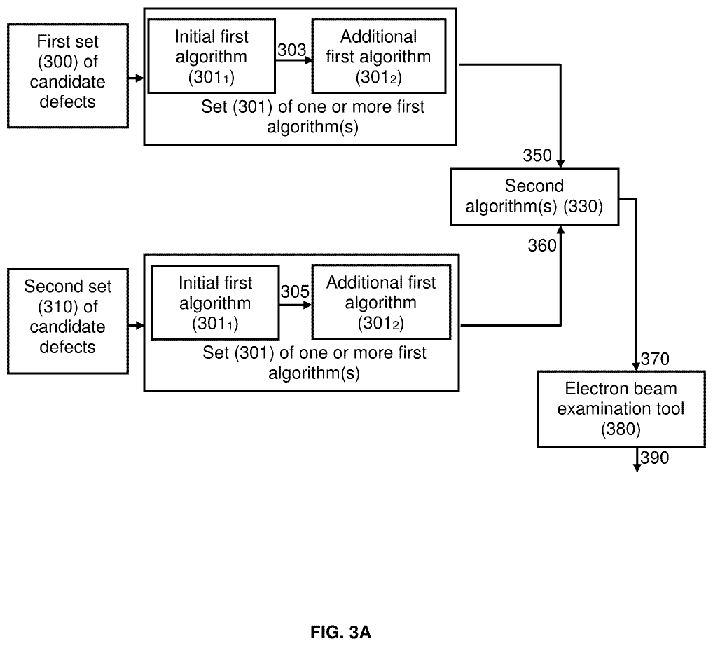

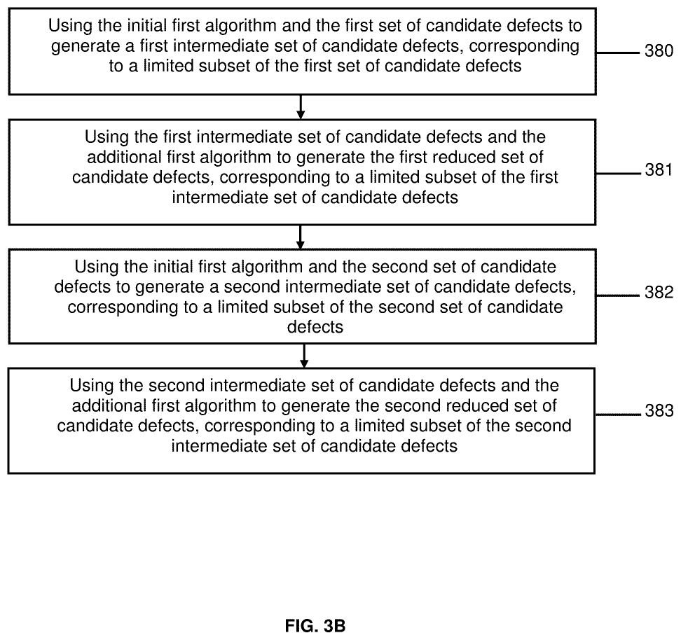

Attention is now drawn to FIG. 2 and FIG. 3A. FIG. 2 describes a method enabling defect defection in an image of a semiconductor specimen. FIG. 3A illustrates a non-limitative example of an architecture in which multiple algorithms are used to perform the method of FIG. 2.

The method of FIG. 2 includes obtaining (operation 200) a first set 300 of candidate defects of a semiconductor specimen. The first set 300 of candidate defects has been obtained based on at least one image of the semiconductor specimen acquired by an inspection tool 101 associated with a first set of acquisition parameters. In particular, during scanning of the specimen, the inspection tool 101 is associated with this first set of acquisition parameters.

The first set 300 of candidate defects includes information on the location of the candidate defects. The first set 300 can be obtained by using a defect detection algorithm (not represented in FIG. 3), which receives the image of the specimen acquired by the inspection tool 101 as an input, and outputs the first set 300 of candidate defects. The defect detection algorithm can be implemented for example as a machine learning model.

As mentioned above, the inspection tool 101 can correspond to an optical examination tool. The acquisition parameters of the inspection tool 101 can include (but are not limited to): landing energy, beam resolution, current amplitude, current density, lens settings, aperture size, and numerical aperture (NA), etc. In some examples, the acquisition parameters correspond to a certain optical configuration of the inspection tool 101.

The method of FIG. 2 further includes obtaining (operation 210) a second set 310 of candidate defects of the semiconductor specimen. The second set 310 of candidate defects has been obtained based on at least one image of the semiconductor specimen acquired by the inspection tool 101 associated with a second set of acquisition parameters. In particular, during scanning of the specimen, the inspection tool 101 is associated with this second set of acquisition parameters. The second set of acquisition parameters is different from the first set of acquisition parameters. The usage of different acquisition parameters enables acquiring information on different defects and/or different layers and/or different structural elements. Therefore, the second set 310 of candidate defects differs from the first set 300 of candidate defects.

The second set 310 can be obtained by using a defect detection algorithm (not represented in FIG. 3), which receives the image of the specimen acquired by the inspection tool 101 as an input, and outputs the second set 310 of candidate defects.

Note that it is possible to obtain, for a given specimen, more than two sets of candidate defects (such as N different sets of candidate defects, with N≥2). In this case, each set of candidate defects is obtained based on an image acquired by the inspection tool 101 with a different set of acquisition parameters.

The method of FIG. 2 further includes using (operation 220) the set 301 of one or more first algorithms to generate, based on the first set 300 of candidate defects, a first reduced set 350 of candidate defects. The first reduced set 350 of candidate defects includes less candidate defects than the first set 300 of candidate defects. In some non-limitative examples, the first set 300 of candidate defects includes around 1 million candidate defects, and the first reduced set 350 of candidate defects includes around a few hundred candidate defects. These numbers are not limitative and other numbers can be used.

The method of FIG. 2 further includes using (operation 230) the set 301 of one or more first algorithms to generate, based on the second set 310 of candidate defects, a second reduced set 360 of candidate defects. The second reduced set 360 of candidate defects includes less candidate defects than the second set 310 of candidate defects. In some non-limitative examples, the second set 310 of candidate defects includes around 1 million candidate defects, and the second reduced set 360 of candidate defects includes around a few hundred candidate defects. These numbers are not limitative and other numbers can be used.

The method of FIG. 2 further includes feeding (operation 240) at least part of the first reduced set 350 of candidate defects and at least part of the second reduced set 360 of candidate defects to the second algorithm 330 (also called global filter) to generate a unified set 370 of candidate defects.

The unified set 370 of candidate defects includes less candidate defects than the total number of candidate defects included in the first and second reduced set of candidate defects 350, 360 (considered as a whole).

The method of FIG. 2 further includes providing (operation 250) the unified set 370 of candidate defects to a review tool 102. As mentioned above, in some examples, the review tool 102 is an electron beam examination tool 380, such as a SEM. The electron beam examination tool 380 is used to review the unified set 370 of candidate defects. For each candidate defect of the unified set 370 of candidate defects, the electron beam examination tool 380 indicates whether it corresponds to a defect or not. A map 390 of defects is therefore obtained. This map 390 can be provided to the manufacturer of the specimen, and can be used for various purposes, such as improving the manufacturing process, identifying defective specimens, etc.

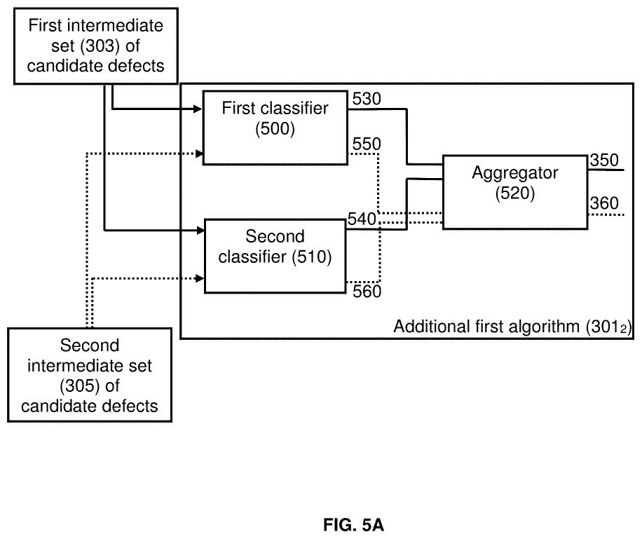

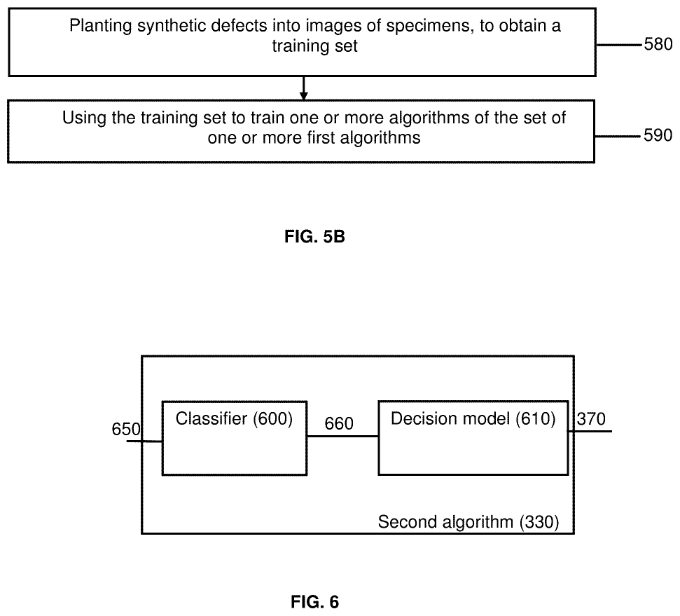

In the architecture of FIG. 3A, a set 301 of one or more first algorithms is used in combination with a second algorithm 330 (global filter). In some examples, the set 301 includes one or more first algorithms which are unsupervised algorithms. In particular, the training of the one or more first algorithms is fully or partially unsupervised. In some examples, as explained with reference to FIG. 5B, the label of the training images used to train the first algorithm(s) is automatically generated, without requiring user intervention.

In some examples, the second algorithm 330 is a supervised algorithm. In particular, the training of the second algorithm 330 can be supervised. Supervised training includes user intervention, in order to generate labels of the training images used to train the second algorithm 330. This is however not limitative.

According to some examples, and as visible in FIG. 3A, the set 301 of one or more first algorithms can include a plurality of algorithms. In particular, the set 301 can include an initial first algorithm 3011, followed by an additional first algorithm 3012. As explained with reference to FIG. 3B, at least part or all of the output of the initial first algorithm 3011 is processed by the additional first algorithm 3012. Note that this is possible to run the initial first algorithm a plurality of times (in order to enable parallel processing of different sets of candidate defects) and/or to run the additional first algorithm a plurality of times (in order to enable parallel processing of different sets of candidate defects). This is not limitative, and it is possible to use the sets of one or more first algorithms sequentially, each time to process a different set of candidate defects.

The initial first algorithm 3011 receives as an input the first set 300 of candidate defects and generates a first intermediate set 303 of candidate defects, corresponding to a limited subset of the first set 300 of candidate defects (operation 380 in FIG. 3B). The first intermediate set 303 of candidate defects includes less candidate defects that the candidate defects included in the first set 300 of candidate defects. In some non-limitative examples, the first set 300 of candidate defects includes around 1 million candidate defects, and the first intermediate set 303 of candidate defects includes around 10.000 candidate defects. These values are not limitative.

The first intermediate set 303 of candidate defects is then fed to the additional first algorithm 3012, which generates the first reduced set 350 of candidate defects, corresponding to a limited subset of the first intermediate set 303 of candidate defects (operation 381 in FIG. 3B). The first reduced set 350 of candidate defects includes less candidate defects than the first intermediate set 303 of candidate defects.

Similarly, the initial first algorithm 3011 receives as an input the second set 310 of candidate defects and generates a second intermediate set 305 of candidate defects, corresponding to a limited subset of the second intermediate set 310 of candidate defects (operation 382 in FIG. 3B). The second intermediate set 305 of candidate defects includes less candidate defects than the candidate defects included in the second set 310 of candidate defects. In some non-limitative examples, the second set 310 of candidate defects includes around 1 million candidate defects, and the second intermediate set 305 of candidate defects includes around 10.000 candidate defects. These values are not limitative.

The second intermediate set 305 of candidate defects is then fed to the additional first algorithm 3012, which generates the second reduced set 360 of candidate defects, corresponding to a limited subset of the second intermediate set 305 of candidate defects (operation 383 in FIG. 3B). The second reduced set 360 of candidate defects includes less candidate defects than the second intermediate set 305 of candidate defects.

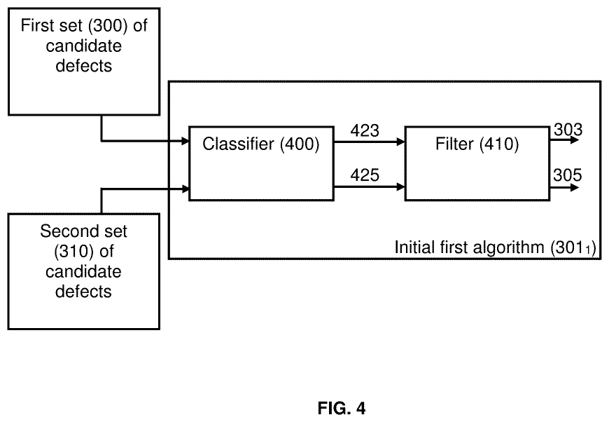

Attention is now drawn to FIG. 4, which depicts an implementation of the initial first algorithm 3011, according to some examples of the invention.

In some examples, the initial first algorithm 3011 includes a classifier 400 and a filter 410. The first set 300 of candidate defects (in some examples, together with the image(s) of the specimen from which the first set 300 has been generated) is fed to the classifier 400. The classifier 400 assigns to each candidate defect of the first set 300 a label (“true”, indicative of a suspected defect, or “false” indicative of the absence of defects). This enables generating a list 423 of candidate defects, which corresponds to the candidate defects associated with a label equal to “true”. The classifier 400 can be implemented as various types of models, such as machine learning models (e.g., linear classifiers, support vector machines (SVMs), neural networks, decision trees, etc.).

The list 423 of candidate defects is fed to the filter 410. The filter 410 filters the list 423 of candidate defects generated by the classifier 400 and outputs the first intermediate set 303 of candidate defects (corresponding to a limited subset of the first reduced set 350 of candidate defects, and to a limited subset of the list 423). The number of candidate defects in the first intermediate set 303 is smaller than in the list 423 of candidate defects (and a fortiori than in the first reduced set 350 of candidate defects).

Similarly, the second set 310 of candidate defects (in some examples, together with the image of the specimen from which the second set 310 has been generated) is fed to the classifier 400. The classifier 400 assigns to each candidate defect of the second set 310 a label (“true”, indicative of a suspected defect, or “false” indicative of the absence of defects). This enables generating a list 425 of candidate defects, which corresponds to the candidate defects associated with a label equal to “true”.

The list 425 of candidate defects is fed to the filter 410. The filter 410 filters the list 425 of candidate defects generated by the classifier 400 and outputs the second intermediate set 305 of candidate defects. The number of candidate defects in the second intermediate set 305 is smaller than in the list 425 of candidate defects.

The filter 410 can operate in a space of attributes. For each candidate defect, a plurality of attributes is obtained or computed (based on pixel intensity, location, etc.) and the filter 410 uses the attributes to generate a map of candidate defects, corresponding to the list 423 of candidate defects (respectively the list 425 of candidate defects).

Examples of attributes can include locations, strength of the signal, size, volume, grade, polarity, etc. of the candidate defects. Optionally, in some cases, additional attributes can be also collected, including image characteristics corresponding to the candidate defect such as, e.g., gray level intensities, contrast, etc., as well as acquisition information, such as acquisition time, acquisition tool ID, region ID, wafer ID, etc.

In some examples, the first set 300 of candidate defects (respectively the second set 310 of candidate defects) can be informative of some or all of the attributes of the candidate defects.

In some examples, the filter 410 is a Random Forest filter. This is not limitative and other types of filters can be used, such as machine learning models, etc.

Attention is now drawn to FIG. 5A, which depicts an implementation of the additional first algorithm 3012, according to some examples of the invention.

In this implementation, the additional first algorithm 3012 includes a first classifier 500 and a second classifier 510, operating in parallel. In some examples, the first and second classifiers 500, 510 correspond to Random Forest algorithms. This is not limitative, and other types of classifiers can be used (e.g., machine learning models).

The first intermediate set 303 of candidate defects is fed to the first classifier 500 which outputs a first list 530 of candidate defects, corresponding to defects with the highest probability. The first classifier 500 selects a limited subset of candidate defects among the first intermediate set 303 of candidate defects, to obtain the first list 530. The first classifier 500 can assign a confidence score to each candidate defect of the first list 530, which indicates the level of confidence that this candidate defect actually corresponds to a defect.

The first intermediate set 303 of candidate defects is also fed to the second classifier 510 which outputs a second list 540 of candidate defects, corresponding to defects with the highest probability. The classifier 510 selects a limited subset of candidate defects among the first intermediate set 303 of candidate defects, to obtain the second list 540. The classifier 510 can assign a confidence score to each candidate defect of the second list 540, which indicates the level of confidence that this candidate defect actually corresponds to a defect.

An aggregator 520 can aggregate the first list 530 and the second list 540 into a list corresponding to the first reduced set 350 of candidate defects. The first reduced set 350 of candidate defects includes less candidate defects than the total number of candidate defects of the first list 530 and the second list 540. This aggregation can take into account the confidence score of each candidate defect, in order to select the candidate defect with the most promising confidence score.

The second intermediate set 305 of candidate defects can be processed similarly. The second intermediate set 305 of candidate defects is fed to the first classifier 500 which outputs a third list 550 of candidate defects, corresponding to defects with the highest probability. The classifier 500 selects a limited subset of candidate defects among the second intermediate set 305 of candidate defects, to obtain the third list 550. The classifier 500 can assign a confidence score to each candidate defects of the third list 550, which indicates the level of confidence that this candidate defect actually corresponds to a defect.

The second intermediate set 305 of candidate defects is also fed to the second classifier 510 which outputs a fourth list 560 of candidate defects, corresponding to defects with the highest probability. The second classifier 510 selects a limited subset of candidate defects among the second intermediate set 305 of candidate defects, to obtain the fourth list 560. The second classifier 510 can assign a confidence score to each candidate defect of the fourth list 560, which indicates the level of confidence that this candidate defect actually corresponds to a defect.

The aggregator 520 can aggregate the third list 550 and the fourth list 560 into a list corresponding to the second reduced set 360 of candidate defects. The second reduced set 360 of candidate defects includes less candidate defects than the total number of candidate defects of the third list 550 and the fourth list 560. This aggregation can take into account the confidence score of each candidate defect, in order to select the candidate defects with the most promising confidence score.

Attention is now drawn to FIG. 5B, which depicts a method of generating a training set, usable to train one or more of the algorithms of the set 301 of one or more first algorithms.

The method of FIG. 5B includes planting (operation 580) synthetic defects into one or more images of one or more specimens. This enables obtaining a training set of images. Since the location (and other characteristics) of the synthetic defects (also called planted defects) are known, a label can be generated automatically for each training image. The label can include data informative of the location of each synthetic defect in the corresponding training image. If necessary, the label can further include data informative of the synthetic defects.

The method of FIG. 5B further includes using (operation 590) the training set to train one or more algorithms of the set of one or more first algorithms. This enables training one or more algorithms of the set of one or more first algorithms in an unsupervised manner. Indeed, as mentioned above, the label of each training image can be generated automatically and does not require user intervention.

Planting a synthetic defect in one or more images can include obtaining characteristics of one or more defects to be planted within the one or more images. The characteristics may include a type, geometrical characteristics, amplitude, parity, electrical characteristics, physical characteristics, a color, or the like. In some examples, the synthetic defect can be associated with absolute values to be assigned to pixels at the location. In some examples, the synthetic defect can be associated with a value to be added, subtracted, or otherwise used to manipulate an existing value of one or more pixels. In some examples, the synthetic defect can be associated with a value of one or more pixels relative to the environment, for example a value of 10% or 20% more than the average value of one or more surrounding pixels. In some examples, the synthetic defect may affect the values of pixels by simulating interaction of a material with materials from other layers which may change the color, opacity, or other properties. The location of the synthetic defect(s) can be further obtained.

Planting a synthetic defect in an image can further include modifying the image in accordance with the defect characteristics and location, by modifying the values of one or more pixels in the image. In some examples, the method described in U.S. Pat. No. 11,386,539, incorporated herein by reference in its entirety, can be used.

Attention is now drawn to FIG. 6, which depicts an implementation of the second algorithm 330 (global filter), according to some examples of the invention.

According to some examples, the second algorithm 330 is as described in the patent application U.S. Ser. No. 18/488,888 of the Applicant, incorporated herein in its entirety.

As visible in FIG. 6, the second algorithm 330 includes a classifier 600 and a decision model 610.

The classifier 600 corresponds to a learning model. The classifier 600 can be implemented as various types of machine learning models, such as, e.g., linear classifiers, support vector machines (SVM), neural networks, decision trees, etc., and the present disclosure is not limited by the specific model implemented therewith.

The classifier 600 is fed with an inspection dataset 650, which is informative of a group of candidate defects and attributes thereof resulting from examining a semiconductor specimen by an inspection tool 101. In particular, the inspection dataset 650 can include at least part of the first reduced set 350 of candidate defects (generated by the set 301 of one or more first algorithms based on the first set 300 of candidate defects) and at least part of the second reduced set 360 of candidate defects (generated by the set 301 of one or more first algorithms based on the second set 310 of candidate defects).

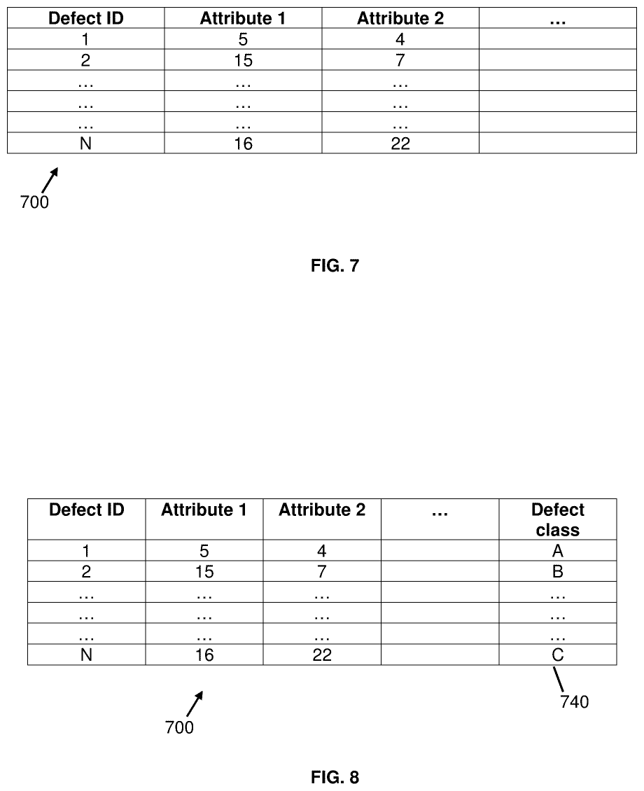

The inspection dataset 650 can be represented as a tabular dataset 700, as exemplified in FIG. 7. This is however not limitative. As the inspection dataset 650 is acquired by an inspection tool 101 in runtime examination (such as an optical tool), it does not include any attributes indicative of defect classes.

Optionally, in some cases, the inspection dataset 650 can be normalized prior to being further processed. The data normalization can be performed in a similar manner as described in U.S. Ser. No. 18/488,888 (see block 306 of FIG. 3 and FIG. 4 in U.S. Ser. No. 18/488,888). The inspection dataset 650 can be normalized by transforming values of each given attribute of at least some of the attributes into a specific distribution, and evaluating transformation error of the transformation, to determine whether to filter the given attribute from the inspection dataset. After data normalization, a normalized dataset is generated, including filtered attributes, each having normalized values.

Optionally, the inspection dataset 650 can be partitioned into a plurality of sub-spaces based on one or more attributes. The sub-spacing can be performed in a similar manner as described in U.S. Ser. No. 18/488,888 (see block 304 of FIG. 3 in U.S. Ser. No. 18/488,888). In such cases, the normalization and the later processing, such as classifying, are respectively performed for each sub-space.

The group of candidate defects of the inspection dataset 650 can be classified by the classifier 600 into a plurality of defect classes 740, such that each candidate defect is associated with a respective defect class 740. A non-limitative example of the output 660 of the classifier 600 is illustrated in FIG. 8, in which a new column 740 is added in the tabular dataset 700, representative of the defect class of each candidate defect (each letter A, B, C, etc. corresponds to a respective defect class).

In some cases, the classifier 600 can classify the defect candidates into two classes: DOI (defect of interest) or nuisance. In such cases, the classifier 600 is a binary classifier and can also be referred to as a filter or a nuisance filter, which is configured to filter out nuisance type of defect candidates from the defect map. In some other cases, the classifier 600 can identify specific defect types of the defect candidates, such as, e.g., a bridge, particle, etc. By way of example, the classifier 600 can classify the defect candidates into DOIs and nuisances, and for the candidates classified as DOI, the classifier 600 can also identify the specific defect type thereof.

In cases of sub-spacing as mentioned above, the normalization and the classifying are respectively performed for each sub-space. The classified defect candidates from each sub-space can be combined and form a group of classified defect candidates as input to the decision model 610.

The group 660 of candidate defects, as output by the classifier 600, can be ranked by the decision model 610 into a total order using a sorting rule. Each candidate defect is associated with a distinct ranking in the total order representative of the likelihood of the defect candidate being a defect of interest (DOI).

A total order, or a full order, as used herein, refers to an order within a group of candidates, where each candidate has a unique/distinct ranking in the order that is non-overlapping with others. For instance, if a group has n defect candidates, after being processed by the trained decision model, the n defect candidates will be respectively ranked from 1 to n, where each candidate has its unique ranking in the order. In other words, there will not be a situation where two or more candidates share the same ranking in this order.

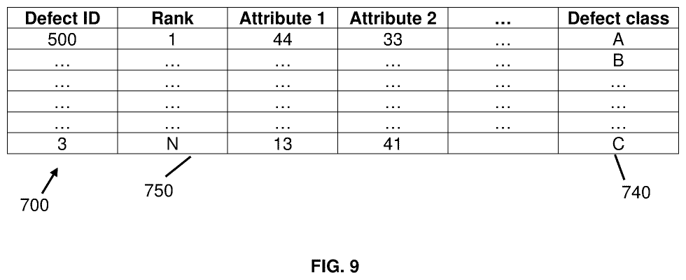

The output of the ranking is exemplified in FIG. 9, where a new column “rank” 750 is added to the tabular dataset 700, and each candidate defect is associated with its unique ranking in the total order.

As mentioned above, the output 370 of the second algorithm 330 corresponds to a map of candidate defects provided to a review tool 120, for review of the candidate defects by the review tool 120.

In some cases, the ranking can be used to select a limited list of defect candidates to be reviewed by the review tool 120. The limited list of candidate defects is selected in accordance with a review budget of the review tool 120 based on the distinct ranking.

The classifier 600 can be previously trained in a similar manner as described in U.S. Ser. No. 18/488,888. In particular, the classifier 600 is previously trained based on a training set including a subset of candidate defects. Each given candidate defect of the training set is associated with a corresponding defect class as provided by a review tool when reviewing the given candidate defect.

The decision model 610 can be previously trained to learn the sorting rule pertaining to the plurality of defect classes. The training set used to train the decision model 610 can include a list of candidate defects, wherein each given candidate defect of the list is associated with a first attribute generated by the classifier 600 (previously trained as explained above) corresponding to an estimate of the defect class of the given candidate defect by the classifier 600, a second attribute corresponding to the actual defect class (ground truth) as provided by a review tool when reviewing the given candidate defect, and additional attributes (e.g., locations, signal strength, size, volume, grade, polarity, etc. of the candidate defect candidates).

The training dataset is used to train the decision model 610, so that the decision model 610 learns a sorting rule pertaining to a series of attributes including the first attribute. The sorting rule is usable for ranking the group of candidate defects into a total order in accordance with the ground truth defect classes indicated by the second attribute. Each candidate defect is associated with a distinct ranking in the total order representative of the likelihood of the defect candidate being a defect of interest (DOI).

By way of example, the training set can be firstly sorted in accordance with the first attribute (i.e., the defect classes of the candidate defects generated by the classifier 600). The sorting can be according to the number or percentage of DOIs included in each defect class. For instance, a tabular dataset including the candidate defects of the training set can be split into multiple subsets, each corresponding to a respective defect class. The subset of candidate defects with a defect class that has the most DOIs (or largest percentage of DOIs) can be placed first in the table. The next subset of candidate defects with a defect class that has the second most DOIs can be placed next to the first subset. The remaining candidates can be arranged in a similar manner, according to a descending order of the DOIs in their defect classes, giving rise to a sorted dataset (e.g., a sorted table).

For each subset of candidate defects in the sorted table (e.g., a sub-table in the sorted table) that corresponds to a respective defect class, the decision model 610 learns what attributes can be used to sort the subset of candidates sequentially so as to achieve an intra-subset order that is consistent with the ground truth defect classes of the candidates in the subset. For instance, for the first subset/sub-table that has the most DOIs in the sorted table, each candidate is associated with a second attribute indicative of its ground truth defect class provided by a review tool. The decision model 610 learns that, among all the attributes (except for the first attribute that is already used in the first sorting, and the second attribute which is the ground truth), when sorting the sub-table using certain selected attributes in a specific order, the candidates that are listed on top are the ones having the ground truth defect classes as DOIs. In other words, the decision model 610 learns how to select attributes and sort the sub-table according to the selected attributes, so as to have the candidates that are reviewed as real defects (DOIs) on top. The decision model 610 can also learn to sort the candidates with the remaining classes in a specific order.

A detailed training process of the decision model 610 is described in U.S. Ser. No. 18/488,888, and can be used herein.

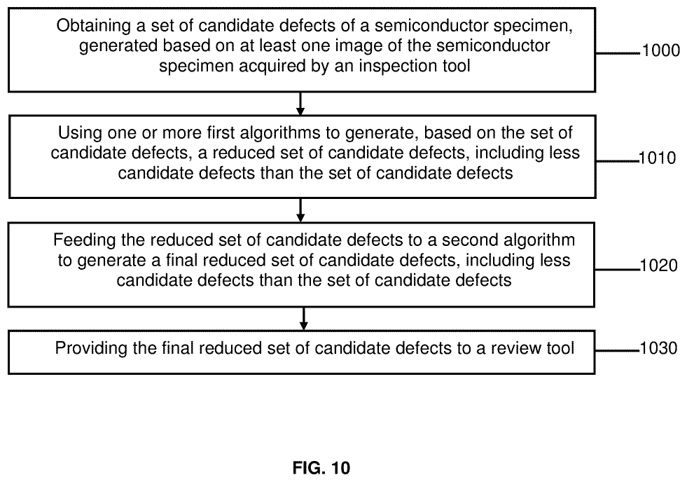

Attention is now drawn to FIG. 10.

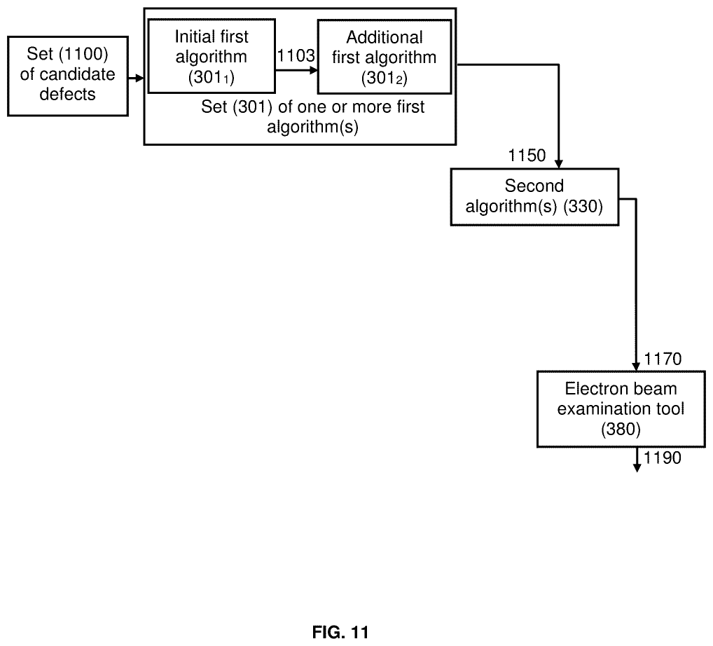

In FIG. 3, an architecture has been described in which a plurality of sets of candidate defects (see 300, 310), corresponding to different acquisition parameters of the inspection tool 110, is fused into a unified set (see 370) of candidate defects. FIGS. 10 and 11 depict a variant in which, each time, a single set of candidate defects is processed, corresponding to a given set of acquisition parameters (given optical configuration). Note that the acquisition parameters can be modified between different sets of candidate defects. This is not limitative.

The method of FIG. 10 includes obtaining (operation 1000) a set 1100 of candidate defects of a semiconductor specimen. The set 1100 of candidate defects has been obtained based on at least one image of the semiconductor specimen acquired by an inspection tool 110.

The set 1100 includes information on the location of the candidate defects. The set 1100 can be obtained by using a defect detection algorithm (not represented in FIG. 10), which receives the image of the specimen as an input, and outputs the set 1100.

The method of FIG. 10 further includes using (operation 1010) the set 301 of one or more first algorithms to generate, based on the set 1100 of candidate defects, a reduced set 1150 of candidate defects. The reduced set 1150 of candidate defects includes less candidate defects than the set 1000 of candidate defects and can correspond to a limited subset of candidate defects of the set 1000 of candidate defects. In some non-limitative examples, the set 1000 of candidate defects includes around 1 million candidate defects, and the reduced set 1150 of candidate defects includes a few hundred candidate defects. These numbers are not limitative, and other numbers can be used.

In some examples, the set 1100 of candidate defects is first processed by the initial first algorithm 301₁, which outputs an intermediate reduced set 1103 of candidate defects (including less candidate defects than the set 1100 of candidate defects). The intermediate reduced set 1103 of candidate defects corresponds to a limited subset of candidate defects of the set 1100 of candidate defects. The intermediate reduced set 1103 of candidate defects is then processed by the additional first algorithm 3012, which generates the reduced set 1150 of candidate defects. The reduced set 1150 of candidate defects corresponds to a limited subset of the intermediate reduced set 1103 of candidate defects.

The method of FIG. 10 further includes feeding (operation 1020) the reduced set 1150 of candidate defects to the second algorithm 330 (global filter) to generate a final set 170 of candidate defects. The final set 170 of candidate defects corresponds to a limited subset of the reduced set 1150 of candidate defects, and therefore includes less candidate defects than the reduced set 1150 of candidate defects.

The method of FIG. 10 further includes providing (operation 1030) the final set 1170 of candidate defects to a review tool, such as an electron beam examination tool 380. The electron beam examination tool 380 is used to review the final set 1170 of candidate defects. For each candidate defect of the final set 1170, the electron beam examination tool 380 indicates whether it corresponds to a defect or not. A map 1190 of defects is therefore obtained.

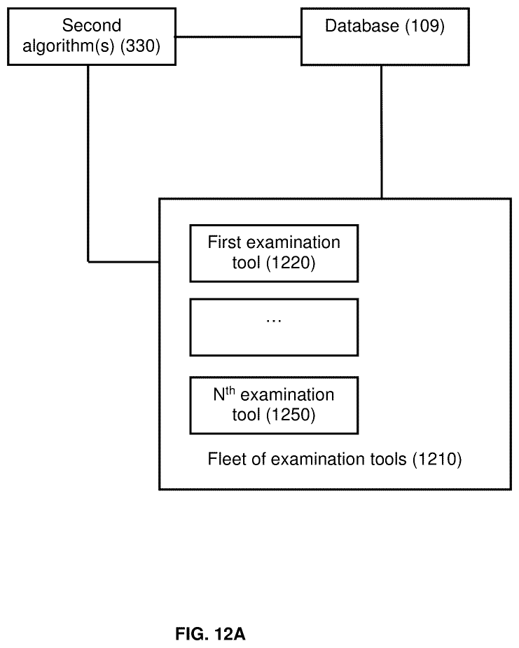

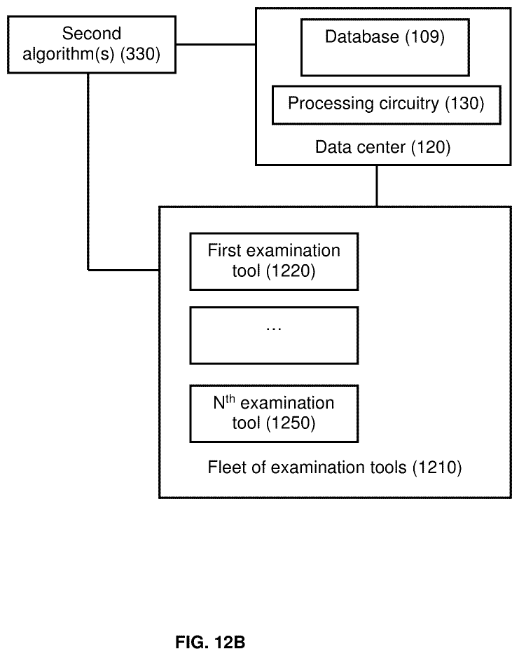

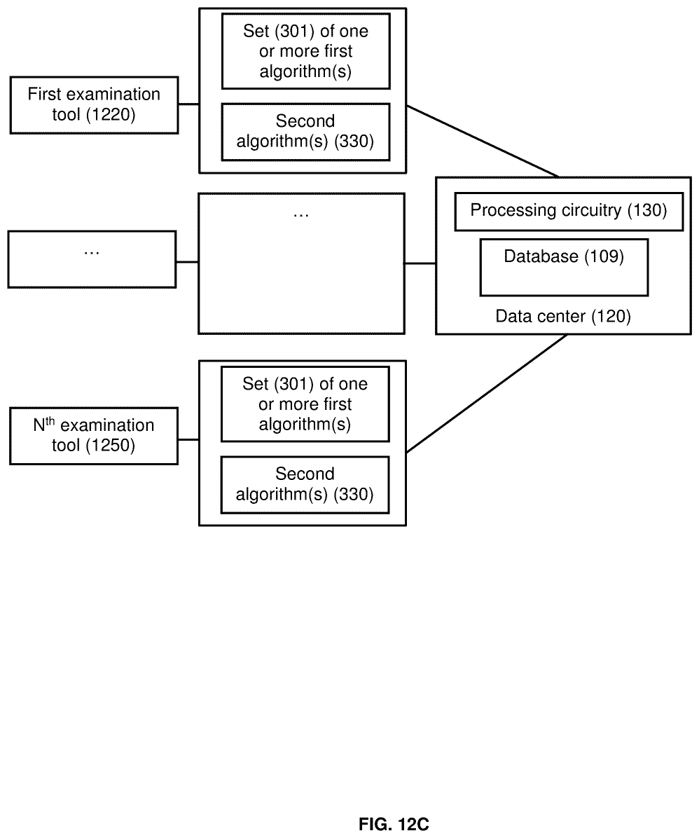

Attention is now drawn to FIGS. 12A and 12B.

FIG. 12A depicts a database 109 (already mentioned with reference to FIG. 1). The database 109 can communicate with the second algorithm 330. In some examples, as visible in FIG. 12B, the database 109 can be part of a data center 120, including the database 109 and one or more processing circuitries 130 (configured to perform operations based on the data present in the database 109).

The database 109 stores data generated by one or more examination tools. In particular, it can store data generated by a fleet 1210 of examination tools (or by a processing circuitry in communication with each of the examination tools), including a plurality of examination tools (first examination tool 1220, . . . , N^{th} examination tool 1250). In other words, the database 109 can centralize data generated by a whole fleet 1210 of examination tools, in an automatic way. The data can be transmitted from each of the examination tools of the fleet 1210, or from a processing circuitry in communication with each of the examination tools, to the database 109, using any adapted communication (wire communication or wireless communication). Transmission of the data can be performed automatically, without requiring user intervention.

In some examples, one or more of the examination tools can correspond to a review tool, configured to determine the presence of defects, and the class of the defects. In some examples, one or more of the examination tools can correspond to an electron beam examination tool, such as a SEM.

The database 109 can store data informative of defects identified by the examination tools of the fleet 1210, in semiconductor specimens. At least part of the data of the database 109 can be generated by the examination tools of the fleet 1210, or can be generated based on the output of the examination performed by the examination tools of the fleet 1210.

Data informative of the defects can include for example (this list is not limitative): location of the defects, attributes of the defects (size, strength of the signal, etc.), class of the defects, etc.

As explained in the various methods described above, the second algorithm 330 (global filter) is configured to generate a reduced set of candidate defects, based either on a plurality of sets of candidate defects (see FIG. 3A, in which the second algorithm 330 converts the first reduced set 350 of candidate defects and the second reduced set 360 of candidate defects into a unified set 370 of candidate defects), or a single set of candidate defects (see FIG. 11, in which the second algorithm 330 converts the set 1150 of candidate defects into a reduced set 1170 of candidate defects). The reduced set of candidate defects, generated by the second algorithm 330 (global filter), is provided to an examination tool (such as one of the examination tools 1220 to 1250 of the fleet 1210), which assigns, to each candidate defect, a label. A positive label (true) indicates the presence of a defect, and a negative label (false) indicates the absence of a defect.

The database 109 can store, for each candidate defect provided by the second algorithm 330 to one or more of the examination tools of the fleet 1210, the corresponding label provided by the examination tool. As mentioned, the label corresponds to the output of the examination by the examination tool, for each candidate defect.

In some examples, the database 109 stores, for each candidate defect of a plurality of candidate defects identified by one or more other algorithms operative to identify defects of interest (based on an image acquired by an inspection tool), a corresponding label (also called ground truth) provided by a review tool, which indicates whether the candidate defect corresponds to a real defect.

In some examples, the data stored in the database 109 can be used to train, or retrain, the second algorithm 330, or another algorithm operative to identify defects of interest (DOI) in a map of defects.

Retraining of the second algorithm 330, or of another algorithm operative to identify defects of interest in a map of defects, can be performed automatically, without requiring user intervention. Examples of methods enabling training of the second algorithm 330 have been provided above. Triggering of the retraining of the second algorithm 330 can be performed when a condition is met. The condition can indicate that a sufficient amount of new data has been collected in the database 109, and/or that a sufficient amount of time has elapsed from the previous retraining.

Once the second algorithm 330 has been retrained, an alert can be raised, which indicates that the model of the second algorithm 330 has been retrained and is ready for usage.

In some examples, once the second algorithm 330 has been retrained, it can be transmitted to different locations, and/or to different examination tools. Assume for example that each examination tool of the fleet is associated with an implementation of the second algorithm 330. For example, each respective examination tool of the fleet communicates with a respective processing circuitry implementing the second algorithm 330. Once the retraining of the second algorithm 330 has been performed (for example, by a processing circuitry which is operative to use data of the database 109 for retraining the second algorithm 330, such as the processing circuitry 130, or the processing circuitry 104), the retrained second algorithm 330 can be transmitted to each examination tool of the fleet. In other words, data is collected from the fleet of examination tools, which is then used to automatically retrain the second algorithm 330. The retrained second algorithm 330 is then distributed across the different examination tools of the fleet, in an automatic manner.

Retraining of the second algorithm 330 can be performed in a centralized location, such as at the data center 120. The updated (retrained) second algorithm 330 is then circulated across the different examination tools of the fleet and replaces the previous version of the second algorithm 330. An automatic and continuous retraining is obtained. Note that this method can be performed similarly to retraining another algorithm operative to determine data informative of defects or candidate defects, which is different from the second algorithm 330.

A non-limitative example is provided in FIG. 12C, in which each review tool (see 1220, . . . , 1250) is associated with a set 101 of one or more first algorithms and a second algorithm 330. Data informative of the candidate defects, as provided by the second algorithm 330 associated with each review tool 1220, . . . , 1250, together with the review of each candidate defect performed by each review tool 1220, . . . , 1250, is transmitted to the database 109. When sufficient data is collected, the second algorithm 330 is retrained. This retraining can be performed at the data center 120. The updated second algorithm 330 can be transmitted to each of the examination tools (first review tool 1220, . . . , N^{th} review tool 1250).

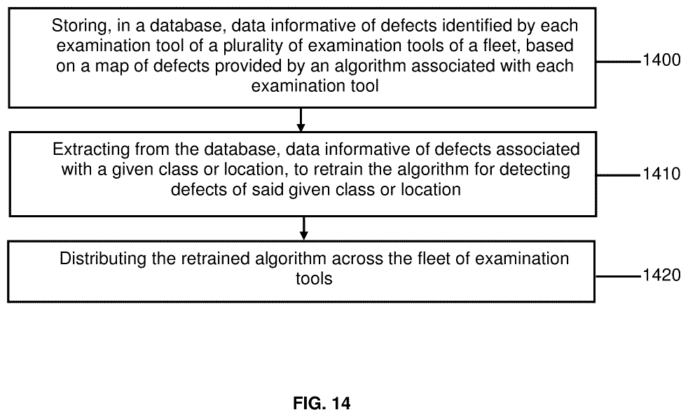

Attention is now drawn to FIG. 14.

The method of FIG. 14 includes storing (operation 1400), in the database 109, data informative of defects identified by each examination tool of a plurality of examination tools of a fleet, based on a map of defects provided by an algorithm (such as the second algorithm 330) associated with each examination tool. Operation 1400 is similar to operation 1300.

The method of FIG. 14 further includes extracting (operation 1410) from the database 109, data informative of defects associated with a given class or location. Indeed, as mentioned above, the database stores, for each defect (or candidate defect), data informative thereof, such as its class, or its location. Assume that it is desired to train (or retrain) the second algorithm 330 to detect defects in a specific layer. It is therefore possible to extract data from the database 109, which is informative of defects located in this specific layer. The extracted data is then used to retrain the second algorithm 330 (operation 1410). The updated second algorithm 330 is then circulated (operation 1420) across one or more of the different examination tools of the fleet and replaces the previous version of the second algorithm 330.

In the detailed description, numerous specific details have been set forth in order to provide a thorough understanding of the disclosure. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, as apparent from the aforementioned discussions, it is appreciated that throughout the specification discussions utilizing terms such as “obtaining”, “applying”, “determining”, “performing”, “using”, “estimating”, “training”, “feeding”, or the like, refer to the action(s) and/or process(es) of a computer that manipulate and/or transform data into other data, said data represented as physical, such as electronic, quantities, and/or said data representing the physical objects.

The terms “computer” or “computer-based system” should be expansively construed to include any kind of hardware-based electronic device with a data processing circuitry (e.g., digital signal processor (DSP), a GPU, a TPU, a field programmable gate array (FPGA), an application specific integrated circuit (ASIC), microcontroller, microprocessor etc.), including, by way of non-limiting example, the computer-based system 103 of FIG. 1 and respective parts thereof disclosed in the present application. The data processing circuitry (designated also as processing circuitry) can comprise, for example, one or more processors operatively connected to computer memory, loaded with executable instructions for executing operations, as further described below. The data processing circuitry encompasses a single processor or multiple processors, which may be located in the same geographical zone, or may, at least partially, be located in different zones, and may be able to communicate together. The one or more processors can represent one or more general-purpose processing devices such as a microprocessor, a central processing unit, or the like. More particularly, a given processor may be one of a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The one or more processors may also be one or more special-purpose processing devices such as an application specific integrated circuit (ASIC), a field programmable gate array (FPGA), a digital signal processor (DSP), a network processor, or the like. The one or more processors are configured to execute instructions for performing the operations and steps discussed herein.

The memories referred to herein can comprise one or more of the following: internal memory, such as, e.g., processor registers and cache, etc., main memory such as, e.g., read-only memory (ROM), flash memory, dynamic random access memory (DRAM) such as synchronous DRAM (SDRAM) or Rambus DRAM (RDRAM), etc.

The terms “non-transitory memory” and “non-transitory storage medium” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of instructions. The terms shall also be taken to include any medium that is capable of storing or encoding a set of instructions for execution by the computer and that cause the computer to perform any one or more of the methodologies of the present disclosure. The terms shall accordingly be taken to include, but not be limited to, a read only memory (“ROM”), random access memory (“RAM”), magnetic disk storage media, optical storage media, flash memory devices, etc.

It is to be noted that while the present disclosure refers to the processing circuitry 104 (or 130) being configured to perform various functionalities and/or operations, the functionalities/operations can be performed by the one or more processors of the processing circuitry 104 in various ways. By way of example, the operations described hereinafter can be performed by a specific processor, or by a combination of processors. The operations described hereinafter can thus be performed by respective processors (or processor combinations) in the processing circuitry 104, while, optionally, at least some of these operations may be performed by the same processor. The present disclosure should not be limited to be construed as one single processor always performing all the operations.

The term “specimen” used in this specification should be expansively construed to cover any kind of wafer, masks, and other structures, combinations and/or parts thereof used for manufacturing semiconductor integrated circuits, magnetic heads, flat panel displays, and other semiconductor-fabricated articles.

The term “examination” used in this specification should be expansively construed to cover any kind of metrology-related operations, as well as operations related to detection and/or classification of defects in a specimen during its fabrication. Examination is provided by using non-destructive examination tools during or after manufacture of the specimen to be examined. By way of non-limiting example, the examination process can include runtime scanning (in a single or in multiple scans), sampling, reviewing, measuring, classifying and/or other operations provided with regard to the specimen or parts thereof using the same or different inspection tools. Likewise, examination can be provided prior to manufacture of the specimen to be examined, and can include, for example, generating an examination recipe(s) and/or other setup operations. It is noted that, unless specifically stated otherwise, the term “examination”, or its derivatives used in this specification, is not limited with respect to resolution or size of an inspection area. A variety of non-destructive examination tools includes, by way of non-limiting example, scanning electron microscopes, atomic force microscopes, optical inspection tools, etc.

By way of non-limiting example, run-time examination can employ a two-phase procedure, e.g., inspection of a specimen followed by review of sampled locations of potential defects. During the first phase, the surface of a specimen is inspected at high-speed and relatively low-resolution. In the first phase, a defect map is produced to show suspected locations on the specimen having high probability of a defect. During the second phase, at least some of the suspected locations are more thoroughly analyzed with relatively high resolution. In some cases, both phases can be implemented by the same inspection tool, and, in some other cases, these two phases are implemented by different inspection tools.

The term “defect” used in this specification should be expansively construed to cover any kind of abnormality or undesirable feature/functionality formed on a specimen. In some cases, a defect may be a defect of interest (DOI) which is a real defect that has certain effects on the functionality of the fabricated device, thus is in the customer's interest to be detected. For instance, any “killer” defects that may cause yield loss can be indicated as a DOI. In some other cases, a defect may be a nuisance (also referred to as “false alarm” defect) which can be disregarded because it has no effect on the functionality of the completed device, and does not impact yield.

The term “candidate defect” used in this specification should be expansively construed to cover a suspected defect location on the specimen which is detected to have certain probability of being a defect of interest (DOI). Therefore, a candidate defect, upon being reviewed/tested, may actually be a DOI, or, in some other cases, it may be a nuisance, or random noise that can be caused by different variations (e.g., process variation, color variation, mechanical and electrical variations, etc.) during inspection.

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately, or in any suitable sub-combination. In the following detailed description, numerous specific details are set forth in order to provide a thorough understanding of the methods and apparatus.

In embodiments of the presently disclosed subject matter, fewer, more, and/or different stages than those shown in the methods of FIGS. 2, 3B, 5B, 10, 13 and 14 may be executed. In embodiments of the presently disclosed subject matter, one or more stages illustrated in the methods of FIGS. 2, 3B, 5B, 10, 13, and 14 may be executed in a different order, and/or one or more groups of stages may be executed simultaneously.

It is to be understood that the invention is not limited in its application to the details set forth in the description contained herein or illustrated in the drawings.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

The invention is capable of other embodiments and of being practiced and carried out in various ways. Hence, it is to be understood that the phraseology and terminology employed herein are for the purpose of description, and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

1. A system comprising one or more processing circuitries configured to:
obtain a first set of candidate defects of a semiconductor specimen, wherein the first set of candidate defects has been obtained based on at least one image of the semiconductor specimen acquired by an inspection tool associated with a first set of acquisition parameters,
use one or more first algorithms to generate, based on the first set of candidate defects, a first reduced set of candidate defects, comprising less candidate defects than the first set of candidate defects,
obtain a second set of candidate defects of the semiconductor specimen, wherein the second set of candidate defects has been obtained based on at least one image of the semiconductor specimen acquired by the inspection tool associated with a second set of acquisition parameters, different from the first set of acquisition parameters,
use the one or more first algorithms to generate, based on the second set of candidate defects, a second reduced set of candidate defects, comprising less candidate defects than the second set of candidate defects, and
feed at least part of the first reduced set of candidate defects and at least part of the second reduced set of candidate defects to a second algorithm, to generate a unified set of candidate defects.

2. The system of claim 1, further configured to provide the unified set of candidate defects to a review tool, wherein the review tool is an electron beam examination tool.

3. The system of claim 1, wherein the one or more first algorithms are unsupervised algorithms, and the second algorithm is a supervised algorithm.

4. The system of claim 1, wherein (i) or (ii) is met:
(i) at least one algorithm of the one or more first algorithms has been trained with one or more training images comprising one or more synthetic defects planted in the one or more training images;
(ii) at least one algorithm of the one or more first algorithms has been trained with one or more training images comprising one or more synthetic defects planted in the one or more training images, wherein each of the one or more training images is associated with a label indicative of a presence of a synthetic defect, wherein said label does not require user annotation.

5. The system of claim 1, wherein at least one of (i) or (ii) is met:
(i) the one or more first algorithms comprise an initial first algorithm configured to convert the first set of candidate defects into a first intermediate set of candidate defects, comprising less candidate defects than the first set of candidate defects;
(ii) the one or more first algorithms comprise an initial first algorithm configured to convert the second set of candidate defects into a second intermediate set of candidate defects, comprising less candidate defects than the second set of candidate defects.

6. The system of claim 1, wherein at least one of (i) or (ii) is met:
(i) an algorithm of the one or more first algorithms comprises:
a classifier configured to assign to each candidate defect of the first set of candidate defects, a label, and
a filter configured to classify an output of the classifier, based on attributes informative of candidate defects of the first set,
(ii) an algorithm of the one or more first algorithms comprises:
a classifier configured to assign to each candidate defect of the second set of candidate defects, a label, and
a filter configured to classify an output of the classifier, based on attributes informative of candidate defects of the second set.

7. The system of claim 1, wherein at least one of (i) or (ii) is met:
(i) the one or more first algorithms comprise:
an initial first algorithm configured to convert the first set of candidate defects into a first intermediate set of candidate defects, comprising less candidate defects than the first set of candidate defects, and
an additional first algorithm configured to select, in the first intermediate set of candidate defects, a first subset of candidate defects, to generate the first reduced set of candidate defects, comprising less candidate defects than the first intermediate set of candidate defects;
(ii) the one or more first algorithms comprise:
an initial first algorithm configured to convert the second set of candidate defects into a second intermediate set of candidate defects, comprising less candidate defects than the second set of candidate defects, and
an additional first algorithm configured to select, in the second intermediate set of candidate defects, a second subset of candidate defects, to generate the second reduced set of candidate defects, comprising less candidate defects than the second intermediate set of candidate defects.

8. The system of claim 1, wherein an algorithm of the one or more first algorithms comprises two classifiers, wherein an aggregation of respective outputs of the two classifiers enables generating the first reduced set of candidate defects or the second reduced set of candidate defects.

9. The system of claim 1, wherein the second algorithm comprises:
a classifier, configured to classify the first reduced set of candidate defects and the second reduced set of candidate defects into a plurality of defect classes such that each candidate defect is associated with a respective defect class; and
a decision model configured to rank the first reduced set of candidate defects and the second reduced set of candidate defects, using a sorting rule.

10. The system of claim 1, further comprising, or being coupled to, a database storing, for each given candidate defect of a plurality of candidate defects, wherein some of the plurality of candidate defects have been reviewed by a first review tool, and some of the plurality of candidate defects have been reviewed by a second review tool, different from the first review tool:
a label indicative of a presence of a defect, obtained based on review by the first review tool or the second review tool, and
data informative of the given candidate defect.

11. The system of claim 10, wherein at least some of the plurality of candidate defects have been obtained based on an output of said second algorithm.

12. The system of claim 10, configured to use at least part of the data of the database to retrain the second algorithm, or another algorithm implementing a same model as the second algorithm.

13. A system comprising one or more processing circuitries configured to:
obtain a set of candidate defects of a semiconductor specimen, wherein the set of candidate defects has been obtained based on at least one image of the semiconductor specimen acquired by an inspection tool,
use one or more first algorithms to generate, based on the set of candidate defects, a reduced set of candidate defects, comprising less defects than the set of candidate defects, and
feed the reduced set of candidate defects to a second algorithm to generate a final set of candidate defects, comprising less candidate defects than the set of candidate defects.

14. The system of claim 13, wherein the one or more first algorithms are unsupervised algorithms and the second algorithm is a supervised algorithm.

15. The system of claim 13, further comprising, or being coupled to, a database storing, for each given candidate defect of a plurality of candidate defects, wherein some of the plurality of candidate defects have been reviewed by a first review tool, and some of the plurality of candidate defects have been reviewed by a second review tool, different from the first review tool:
a label indicative of a presence of a defect, obtained based on review by the first review tool or the second review tool,
data informative of the given candidate defect.

16. The system of claim 15, wherein the plurality of candidate defects has been obtained based on an output of said second algorithm, or another algorithm implementing a same model as the second algorithm.

17. The system of claim 15, wherein at least one of (i) or (ii) is met:
(i) the one or more processing circuitries, or one or more different processing circuitries, are configured to use at least part of the data of the database to retrain the second algorithm, or another algorithm implementing a same model as the second algorithm;
(ii) the one or more processing circuitries, or one or more different processing circuitries, are configured to use at least part of the data of the database to retrain the second algorithm, or another algorithm implementing a same model as the second algorithm, wherein said retraining is triggered automatically when a condition is met.

18. The system of claim 17, wherein (i) or (ii) is met:
(i) the one or more processing circuitries, or the one or more different processing circuitries, are configured to trigger transmission of the second algorithm after its retraining, or of said another algorithm after its retraining, to the first review tool and the second review tool, or to a first system operative to communicate with the first review tool and to a second system operative to communicate with the second review tool;
(ii) at least part of the data stored in the database is automatically received from a fleet of review tools comprising the first review tool and the second review tool.

19. The system of claim 17, wherein the one or more processing circuitries, or the one or more different processing circuitries, are configured to:
extract, from the database, data associated with candidate defects of a given class or a given location, and
retrain the second algorithm, or said another algorithm implementing a same model as the second algorithm, with said data.

20. A non-transitory computer readable medium comprising instructions that, when executed by one or more processing circuitries, cause the one or more processing circuitries to perform:
obtaining a first set of candidate defects of a semiconductor specimen, wherein the first set of candidate defects has been obtained based on at least one image of the semiconductor specimen acquired by an inspection tool associated with a first set of acquisition parameters,
using one or more first algorithms to generate, based on the first set of candidate defects, a first reduced set of candidate defects, comprising less candidate defects than the first set of candidate defects,
obtaining a second set of candidate defects of the semiconductor specimen, wherein the second set of candidate defects has been obtained based on at least one image of the semiconductor specimen acquired by the inspection tool associated with a second set of acquisition parameters, different from the first set of acquisition parameters,
using the one or more first algorithms to generate, based on the second set of candidate defects, a second reduced set of candidate defects, comprising less candidate defects than the second set of candidate defects, and
feeding at least part of the first reduced set of candidate defects and at least part of the second reduced set of candidate defects to a second algorithm, to generate a unified set of candidate defects.
